(19) United States
(12) Patent Application Publication
(10) Pub. No.: US 2026/0085955 A1
(43) Pub. Date: Mar. 26, 2026

(54) ULTRASONIC FLOWMETER

(71) Applicant: KROHNE Messtechnik GmbH, Duisburg (DE)

(72) Inventors: Michael VOGT, Bochum (DE); Jack MASSAAD, Dordrecht (NL); Arie HUIJZER, Sliedrecht (NL); Jeroen VAN KLOOSTER, Tiel (NL)

(73) Assignee: KROHNE Messtechnik GmbH, Duisburg (DE)

(21) Appl. No.: 19/335,826

(22) Filed: Sep. 22, 2025

(30) Foreign Application Priority Data
Sep. 20, 2024 (DE) 10 2024 127 305.4

(51) Int. Cl. G01F 1/667; G01F 1/66

(52) U.S. Cl. CPC G01F 1/667; G01F 1/662

(57) ABSTRACT

An ultrasonic flowmeter comprising a measuring tube, a first ultrasonic transducer, a second ultrasonic transducer, and a control and evaluation unit. The first ultrasonic transducer and the second ultrasonic transducer are arranged axially offset on the measuring tube. The first ultrasonic transducer is an ultrasonic actuator. The second ultrasonic transducer is an ultrasonic sensor. The control and evaluation unit controls the ultrasonic actuator in the operating state of the ultrasonic flowmeter such that a guided ultrasonic wave is excited in the measuring tube through which a fluid flows. The guided ultrasonic wave propagates in a combined waveguide in an axial direction the measuring tube and the fluid. The ultrasonic sensor receives the guided ultrasonic wave and the control and evaluation unit determines a flow velocity of the fluid by evaluating the received guided ultrasonic wave.

This nonprovisional application claims priority under 35 U.S.C. § 119 (a) to German Patent Application No. 10 2024 127 305.4, which was filed in Germany on Sep. 20, 2024, and which is herein incorporated by reference.

### BACKGROUND OF THE INVENTION

### Field of the Invention

The invention relates to an ultrasonic flowmeter with a measuring tube, a first ultrasonic transducer, a second ultrasonic transducer, and a control and evaluation unit, wherein the first ultrasonic transducer and the second ultrasonic transducer are arranged axially offset on the measuring tube, wherein the first ultrasonic transducer is designed at least as an ultrasonic actuator, wherein the second ultrasonic transducer is designed at least as an ultrasonic sensor, wherein, in the operating state of the ultrasonic flowmeter, the control and evaluation unit controls the ultrasonic actuator in such a way that a guided ultrasonic wave is excited in the measuring tube through which a fluid flows, and the guided ultrasonic wave propagates in a combined waveguide comprising the measuring tube and the fluid in the axial direction of the measuring tube in the measuring tube and the fluid, wherein the ultrasonic sensor receives the guided ultrasonic wave and the control and evaluation unit determines a flow velocity of the fluid by evaluating the received guided ultrasonic wave. In addition, the invention also relates to a method for determining at least one wave mode generated during flow measurement in the ultrasonic flowmeter described above.

### Description of the Background Art

Flow measurement using ultrasonic waves are known. Regardless of which measurement method is used (for example, transit time measurement, transit time difference measurement (with the flow direction and against the flow direction), frequency measurement/Doppler effect), flow measurement is always based on the transmission of ultrasonic waves in the fluid flowing through the measuring tube, whose flow velocity is to be captured.

In the vast majority of ultrasonic flowmeters, the characteristic cross-sectional dimensions of the measuring tube (in the case of a round measuring tube, the diameter) are significantly larger than the wavelength of the ultrasonic waves generated by the ultrasonic actuator. Beam forming measures are often implemented. As a result, in these cases, the ultrasonic waves propagating in the fluid inside the measuring tube can be regarded and described as free waves, in whose propagation the measuring tube plays no significant role, apart from reflections at the measuring tube wall.

This changes in the case of ultrasonic flowmeters with measuring tubes whose characteristic cross-sectional dimensions are in the range of the wavelength of the ultrasonic waves used. In this case, the measuring tube wall is a geometric boundary condition for the movement and propagation of the ultrasonic waves that must always be taken into account. The ultrasonic waves then propagate as guided sound waves in the combined or hybrid waveguide comprising the measuring tube and the fluid, i.e., the guided ultrasonic waves move both guided by the measuring tube and guided by the fluid. This invention refers to ultrasonic flowmeters that operate according to this principle.

For clarification, it should be noted that the operating principle described above, on which the present invention is based, differs from guided wave ultrasonic flowmeters in which the ultrasonic waves are guided only in the measuring tube. Depending on the type of ultrasonic wave excited and guided in the measuring tube, ultrasonic waves are transmitted from the measuring tube into the fluid to varying degrees, but they propagate in the fluid as unguided ultrasonic waves, i.e., as free-space waves. Such flowmeters are also referred to as leaky Lamb wave flowmeters, which operate with guided Lamb waves in the measuring tube wall and with free-space ultrasonic waves in the medium caused by this. Ultrasonic flowmeters operating according to this principle are not covered by this invention.

Depending on the geometric and physical boundary conditions of the measuring tube, the fluid parameters, and the frequency of the excited ultrasonic waves, different vibration modes can propagate on the waveguide comprising the measuring tube and the fluid, wherein the wave modes have different spatial and temporal propagation characteristics. Wave modes can be selected to be more or less advantageous.

### SUMMARY OF THE INVENTION

It is therefore an object of the invention to provide an ultrasonic flowmeter with which guided ultrasonic waves can be excited and/or received in an advantageous manner, as well as to provide a method with which advantageous vibration modes in which the guided ultrasonic waves are excited can be determined.

The object is achieved, in an example, in that at least the ultrasonic transducer designed as an ultrasonic actuator has several excitation structures in the axial direction of the measuring tube, wherein the excitation structures are spaced apart from each other in the axial direction of the measuring tube. By means of the excitation structures, ultrasonic waves are fed into the measuring tube through which the fluid flows, so that a wave pattern of at least one predetermined wave mode of the guided ultrasonic wave is excited in the measuring tube through which the fluid flows, spatially distributed in the axial direction of the measuring tube.

The fact that ultrasonic waves are fed into the fluid flowing through the measuring tube by means of the excitation structures means that the excitation structures have contact surfaces with the measuring tube and/or the fluid guided in the measuring tube in some way, wherein acoustic excitation of the measuring tube and/or fluid takes place via the contact surfaces, so energy transfer takes place here. In the free spaces between the excitation structures caused by the spacing, there is no excitation of the measuring tube and/or fluid, at least no active excitation; a small amount of parasitic excitation may be unavoidable in some cases, but this does not contradict the teaching presented here.

A sound wave propagating in a mode determined by the medium and the measuring tube along the axial course of the measuring tube exhibits a spatial (measuring tube extension) and temporal dependence. If a determined location of the measuring tube is considered, a temporal amplitude change can be observed; if the entire measuring tube is considered at a determined point in time, a spatial progression of the amplitude of the sound wave can be observed. Overall, the ultrasonic wave at a determined frequency in a specific mode has a characteristic spatial-temporal signature along the waveguide—from the ultrasonic actuator to the ultrasonic sensor—in the form of the measuring tube through which the fluid flows.

The big advantage of the ultrasonic flowmeter according to the invention is that several acoustic excitations can be generated simultaneously or with a time delay by means of several excitation structures spaced apart from each other at several locations along the extension of the measuring tube. These excitations are selected so that they correspond exactly to the characteristic space-time signature, i.e., the wave pattern of the ultrasonic wave propagating through the measuring tube through which the fluid flows, of the predetermined wave mode.

The multiple spaced excitation structures implement an extensive, structured excitation coating along the extension of the measuring tube, enabling more specific excitation of a desired (or several desired) and therefore predetermined wave mode than is possible with a single excitation location (as seen in the extension of the measuring tube). The wave pattern of the desired, predetermined wave mode can be practically imprinted spatially and temporally in the flowed-through measuring tube. This automatically achieves increased selectivity in the excitation of wave modes than with a single excitation source, thus automatically suppressing unwanted wave modes more effectively. It is even possible to influence the intensity with which wave modes propagate to the left and right of the excitation structures, thus enabling selective suppression of unwanted wave modes in the direction of the ultrasonic sensor and selective promotion of desired, i.e., predetermined wave modes in the direction of the ultrasonic sensor.

An exemplary design of the ultrasonic flowmeter is characterized in that the second ultrasonic transducer, which is designed as an ultrasonic sensor, can be designed like the first ultrasonic transducer, which is designed as an ultrasonic actuator, i.e., with several excitation structures, so that the excitation structures act as detection structures. In particular, the second ultrasonic transducer is identical in design to the first ultrasonic transducer designed as an ultrasonic actuator.

By implementing the ultrasonic sensor with multiple excitation structures acting as detection structures, it is fundamentally possible to selectively capture and recognize a specific wave mode of the guided ultrasonic wave, and unwanted wave modes can be filtered out spatially and temporally, solely by the geometric arrangement of the multiple excitation/detection structures, but also by temporal windowing or by summing appropriately delayed receive signals from the individual excitation/detection structures.

The first ultrasonic transducer can also be designed as an ultrasonic sensor and the second ultrasonic transducer is also designed as an ultrasonic actuator. Here, for example, the excitation structures can be implemented using piezo elements, which can be used as actuators or sensors as required. Given that many ultrasonic flowmeters implement a transit time difference measurement, i.e., perform a transit time measurement with and against the direction of flow of the fluid, it also makes sense to have the same design for the first and second ultrasonic transducers. Preferably, the control and evaluation unit then operates the first ultrasonic transducer and the second ultrasonic transducer in such a way that the flow velocity of the fluid in the measuring tube is determined via a transit time difference measurement.

The measuring tube in the area of the excitation structures can be designed as an acoustic coupling piece to improve the sound transmission from the excitation structure to the fluid in the measuring tube (impedance matching). In an alternative further development of the ultrasonic flowmeter, the measuring tube in the area of the excitation structure is formed by the excitation structure itself for direct sound transmission from the excitation structure to the fluid in the measuring tube.

There are very different possibilities for designing the ultrasonic flowmeters with multiple excitation structures described above. Two different design concepts are described below.

A first design concept for the ultrasonic flowmeters according to the invention is characterized in that the excitation structures are formed by at least two rings spaced apart from each other in the axial direction of the measuring tube and surrounding the measuring tube in the circumferential direction. A particularly simple arrangement is when at least three rings are equidistant from each other.

The rings can be separate ultrasonic stimulators, in particular wherein the ultrasonic stimulators can be controlled separately by the control and evaluation unit. It is precisely this design that makes it possible to control the multiple excitation structures spaced apart from each other at multiple locations in the direction of the measuring tube in a time-shifted manner. These excitations are performed in such a way that they cause precisely the wave pattern of the ultrasonic wave of the predetermined wave mode propagating through the measuring tube through which the fluid flows. The advantage of the time-variable and separate controllability of the ultrasonic stimulators in the form of rings is the ability to adapt to changing boundary conditions, for example, if the composition of the fluid changes or if there is a change in temperature.

In a further example, the multiple excitation structures designed as rings can be controlled simultaneously by the control and evaluation unit, which simplifies the design of the control and evaluation unit. In this case, the distances between the separate rings should be selected so that they cause exactly the wave pattern of the ultrasonic wave of the predetermined wave mode propagating through the measuring tube through which the fluid flows.

The examples show that when exciting the predetermined wave mode in the measuring tube through which the fluid flows, there are basically two degrees of freedom for exciting the spatio-temporal signature of the desired wave mode (at a certain frequency), namely spatially the distances between the excitation structures and temporally the excitation times of the individual excitation structures (if separately excitable).

Special designs of the ultrasonic flowmeter working with excitation structures implemented as rings are characterized in that the rings are contacted by the control and evaluation unit via an inner and outer lateral surface of the rings. (radial operating mode) or that the rings are contacted and controlled by the control and evaluation unit via two opposite base surfaces (axial operating mode); this is particularly useful if the excitation structures designed as rings are piezo elements or at least have piezo elements.

The rings can be mounted in a common ring holder, in particular they are connected to the common ring holder via their lateral surfaces, wherein the common ring holder at least partially comprises material that dampens the crosstalk of ultrasonic waves between the plurality of rings. The advantage of this approach is that the multiple rings can be configured in the ring holder, i.e., they can be securely positioned at the desired distances, for example, and only then applied to the measuring tube. This has advantages in terms of handling, especially in the case of so-called clamp-on configurations.

The rings of the ultrasonic actuator can be controlled with a time delay in the direction of the ultrasonic sensor, so that the ultrasonic wave is amplified in the predetermined wave mode in the direction of the ultrasonic sensor. This approach also achieves a certain degree of directional selectivity, i.e., amplification of the ultrasonic wave in the direction from the ultrasonic actuator to the ultrasonic sensor.

In an example of the ultrasonic flowmeter, in which the ultrasonic sensor, like the ultrasonic actuator, is also designed with several excitation structures, selectivity in the capture of the wave pattern of the predetermined wave mode can be achieved by evaluating the receive signals supplied by the multiple detection structures in a time-gated or time-delayed manner in accordance with the propagation characteristics of the predetermined wave mode. For time gating, for example, the propagation velocity of a desired wave mode and the spatial distance between amplitude maxima at a specific frequency can be used. If no receive signals matching the propagation characteristics of the wave mode are received in the time evaluation windows, this is an indication that the desired wave mode is not present. In the case of temporal delay of signals captured by different capture structures and their subsequent addition, exceeding a signal level can be an indication of the presence of a captured predetermined wave mode, and falling below a signal level can be an indication of the absence of a predetermined wave mode.

The implementation of the ultrasonic flowmeter with multiple annular excitation and detection structures clearly shows that multiple vibration modes can be excited simultaneously. With two rings, there are two degrees of freedom in the design of the excitation structures, namely the spatial spacing of the rings and their time-delayed excitation. Multiple excitation structures automatically provide more degrees of freedom in their design, so that a plurality of modes can also be selectively excited and a plurality of modes can be selectively captured.

A further example for the design of the ultrasonic flowmeters according to the invention is characterized in that the ultrasonic actuator can further comprise a conical base body with a central recess for receiving the measuring tube, wherein an inner wall of the base body formed by the recess is structured by at least one recess extending in the circumferential direction of the measuring tube in the axial direction of the measuring tube, and the at least two projections formed by the at least one recess in the inner wall of the base body form the excitation structures. An ultrasonic stimulator can be arranged at the base of the conical base body, which feeds ultrasonic waves into the conical base body, wherein the ultrasonic waves are at least partially reflected at the lateral surface of the conical base body and excite the guided ultrasonic wave in the measuring tube through which the fluid flows via the projections of the inner wall of the base body. In this design, the projections in the wall of the base body form the contact surfaces for energy transfer to the measuring tube/fluid.

Compared to the first example of the ultrasonic actuator design, the further example has fewer degrees of freedom because the projections are permanently installed in the base body. Ultrasonic waves are also generated only by an ultrasonic stimulator, which feeds the ultrasonic waves into the conical base body, wherein the ultrasonic waves are distributed in the base body by reflection on the lateral surface and are ultimately fed into the waveguide (measuring tube/fluid) via the projections in the wall of the base body.

The ultrasonic stimulator can be designed as a ring, in particular as a ring-shaped piezo element, wherein the ring-shaped piezo element is preferably contacted by the control and evaluation unit via an inner and outer lateral surface of the ring (radial excitation mode). Alternatively, the ring-shaped piezo element is controlled by the control and evaluation unit via two opposite base surfaces (axial excitation mode).

Regardless of whether the ultrasonic actuator is performed according to the first concept or the second concept, it is advantageous in any case if the ultrasonic actuator is performed in multiple parts so that it can be radially attached to the measuring tube, in particular wherein the multiple parts are mounted so that they can pivot relative to each other via one or more hinges. This allows the ultrasonic actuator (and, of course, the correspondingly designed ultrasonic sensor) to be retrofitted onto the measuring tube (clamp-on), eliminating the need for a free end of a pipe to slide the ultrasonic transducers from there onto the measuring tube.

The object described at the beginning is also achieved by a method for determining at least one wave mode that is generated during flow measurement in an ultrasonic flowmeter, which is then used as a predetermined wave mode during operation of the ultrasonic flowmeter. Again, the starting point is an ultrasonic flowmeter with a measuring tube, a first ultrasonic transducer, a second ultrasonic transducer, and a control and evaluation unit. The first ultrasonic transducer and the second ultrasonic transducer are arranged axially offset on the measuring tube, wherein the first ultrasonic transducer is designed at least as an ultrasonic actuator, wherein the second ultrasonic transducer is designed at least as an ultrasonic sensor, wherein the control and evaluation unit, when the ultrasonic flowmeter is in operation, controls the ultrasonic actuator in such a way that a guided ultrasonic wave is excited in the measuring tube through which a fluid flows. The ultrasonic sensor receives the guided ultrasonic wave. The control and evaluation unit determines a flow velocity of the fluid by evaluating the received guided ultrasonic wave. At least the ultrasonic transducer designed as an ultrasonic actuator has several excitation structures in the axial direction of the measuring tube, wherein the excitation structures are spaced apart from each other in the axial direction of the measuring tube. Ultrasonic waves are fed into the measuring tube through which the fluid flows by means of the excitation structures, so that the wave pattern of the determined wave mode of the guided ultrasonic wave is excited in the measuring tube through which the fluid flows, distributed spatially in the axial direction of the measuring tube.

In order to be able to specifically infer an advantageous predetermined wave mode, the phase velocities and group velocities of sound waves in a frequency range are determined for a plurality of wave modes for the geometric and physical boundary conditions of the measuring tube through which the fluid flows. Then, the wave mode that receives the highest rating when evaluating at least one of the criteria listed below at a specific frequency within the frequency range is selected as the predetermined wave mode.

The less the phase velocity and the group velocity differ from each other, the better the rating. This is particularly advantageous with the additional criterion that the closer the phase velocity and/or group velocity is to the sound velocity of the fluid, the better the rating. This criterion ensures that the guided wave is as planar as possible across the cross-section of the measuring tube.

The lower the frequency dependencies of the phase velocity and the group velocity, the better the evaluation. This keeps the dependence on frequency changes during excitation low.

The greater the smallest difference in phase velocity between different modes, the better the evaluation. This ensures that the desired and thus predetermined vibration mode and other, i.e., undesired vibration modes have significantly different wave patterns and can therefore be selectively excited and selectively received.

The greater the smallest difference in group velocity between different modes, the better the evaluation. This ensures that the desired mode has the most different transit time behavior possible compared to other vibration modes, so that the modes can be distinguished as clearly as possible.

The more axisymmetric the mode is, the better it is evaluated. This ensures that the flow measurement is as independent as possible from flow inhomogeneities with respect to the measuring tube axis.

The more similar the relative change in phase velocity and/or group velocity is to a relative change in the sound velocity of the fluid, the better the evaluation. This ensures that the phase velocity and/or group velocity remain as similar as possible to the sound velocity in the fluid, even if it changes. This is advantageous in terms of maintaining a planar waveform, which is preferred because it intrinsically averages the flow velocity profile (in the case of transit time measurement) and thus allows the flow velocity of the fluid to be determined independently of the flow velocity profile.

The smaller the attenuation of the mode amplitude during propagation in the fluid, the better the evaluation. This ensures a good signal strength of the predetermined wave mode.

The more consistent the amplitude of the mode is across the inner cross-section of the measuring tube, the better this is evaluated. This criterion makes the measurement more independent of inhomogeneities in the flow of the fluid across the cross-section of the measuring tube.

A further development of the method provides that, based on the predetermined wave mode and the determined frequency found, a design of the excitation structures is selected, in particular the spatial distance between excitation structures along the measuring tube axis and/or the temporal distance of the excitation of the excitation structures is suitably selected.

A further development of the method concerns a check of the selected design of the excitation structures (including the temporal control of the structures) for their suitability. A check is made as to whether the amplitude achieved of the determined and thus desired mode is sufficiently large, if possible larger than the amplitude of an undesirable mode at the specific frequency. The further development of the method is therefore characterized by that, for the geometric and physical boundary conditions of the measuring tube through which the fluid flows, taking into account the design of the excitation structures, the amplitude of the sound wave generated at an excitation frequency is determined for at least the predetermined wave mode in a frequency range in dependence on the phase velocity of the generated sound wave. The design of the excitation structures is rejected and modified if the amplitude of the determined wave mode does not reach a minimum value, in particular if the amplitude of the determined wave mode at the determined frequency is smaller than the amplitude of an undesirable wave mode. In particular, the process is repeated until a design of the excitation structures that is no longer to be rejected has been found.

The criteria can be evaluated by ranking and grading the wave modes considered and examined on the basis of the criteria, and determining the best mode as the predetermined mode on the basis of the total grade achieved. It has proven practical not to introduce an absolute evaluation scale for each criterion, but rather to use a relative evaluation scale. If, for example, four wave modes are examined, the criteria (e.g., proximity of the phase velocity to the sound velocity in the fluid) are calculated at a given frequency, and the wave mode that best meets the criterion is given a grade of 4, the second-best wave mode a grade of 3, and so on.

If certain criteria are of particular importance, it has proven advantageous to include different criteria with different weightings in the evaluation. In the evaluation example explained above, important criteria could, for example, be weighted twice in the relative evaluation standard.

If, using the method described for determining an advantageous predetermined wave mode, such an advantageous predetermined wave mode has been found at a specific frequency, then this predetermined wave mode is excited at the specific frequency during operation of the ultrasonic flowmeter.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows schematically, an ultrasonic flowmeter known from the conventional art, which operates with guided ultrasonic waves,

FIG. 2 shows schematically, an example of an ultrasonic flowmeter with an ultrasonic actuator having several excitation structures,

FIGS. 3a and 3b show schematically, an ultrasonic actuator with several excitation structures and an acoustic coupling piece as well as direct contact with the fluid,

FIG. 4 shows schematically, an ultrasonic actuator with equidistantly spaced excitation structures,

FIGS. 5a, 5b, and 5c show schematically, ring-shape designed excitation elements as piezo elements with different contacts,

FIGS. 6a, 6b, and 6c show schematically, a multi-piece ultrasonic actuator with sections mounted so that they can pivot relative to each other,

FIG. 7 shows schematically, an ultrasonic flowmeter with an ultrasonic actuator and an ultrasonic sensor, which have a conical base body with several excitation structures,

FIG. 8 shows schematically, the ultrasonic actuator according to FIG. 7 in greater detail,

FIG. 9 shows schematically, a method for determining a suitable wave mode, which is used as a predetermined wave mode when operating one of the ultrasonic flowmeters described above,

FIGS. 10a and 10b show schematically, the phase and group velocities of different wave modes for a specific configuration of an ultrasonic flowmeter, and

FIGS. 11a and 11b show schematically, the amplitudes of the excited ultrasonic waves dependent on the excitation frequency and the applicable phase velocity, once in the positive propagation direction and once in the negative propagation direction.

### DETAILED DESCRIPTION

The figures show various aspects of ultrasonic flowmeters 1, wherein the ultrasonic flowmeters 1 comprise a measuring tube 2, a first ultrasonic transducer 3, a second ultrasonic transducer 4, and a control and evaluation unit 5. The first ultrasonic transducer 3 and the second ultrasonic transducer 4 are arranged axially offset on the measuring tube 2, and the first ultrasonic transducer 3 is designed at least as an ultrasonic actuator 6 and the second ultrasonic transducer 4 is designed at least as an ultrasonic sensor 7. When the ultrasonic flowmeter 1 is in operation, the control and evaluation unit 5 controls the ultrasonic actuator 6 in such a way that a guided ultrasonic wave 9 is excited in the measuring tube 2 through which a fluid 8 flows. The ultrasonic sensor 7 receives the guided ultrasonic wave 9 and the control and evaluation unit 5 determines a flow velocity v of the fluid 8 by evaluating the received guided ultrasonic wave 9.

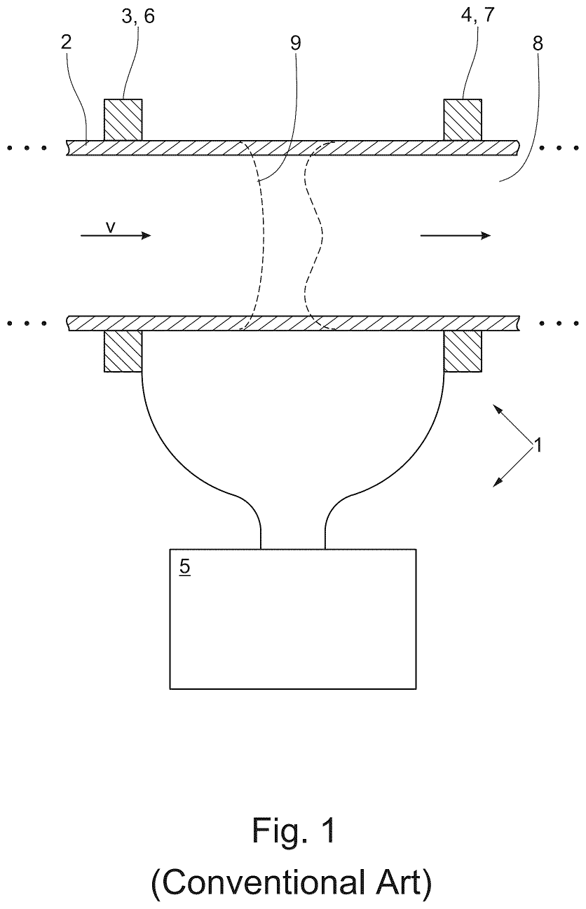

FIG. 1 shows an ultrasonic flowmeter 1 known from the conventional art, which operates with guided ultrasonic waves 9. The measuring tube 2 and the fluid 8 guided in the measuring tube 2 together form a waveguide on which the guided ultrasonic waves 9 propagate. The propagation of guided ultrasonic waves 9 on a waveguide is described by a wave equation, the solution of which must take into account the geometric boundary conditions of the waveguide and, of course, other physical parameters of the arrangement, for example, the medium. It is well known that only certain waveforms, referred to as wave modes, can propagate stably on the waveguide. In the examples shown here, the flow velocity v of the fluid 8 is determined using a time difference method, i.e., the signal transit time of a guided ultrasonic wave 9 is determined with the flow direction and against the flow direction of the fluid 8. This has the advantage that, when calculating the fluid velocity v, the component of the velocity of the ultrasonic wave 9 in the fluid 8 that is identical regardless of the direction of flow of the fluid 8 is automatically canceled out.

In the ultrasonic flowmeter 1 shown in FIG. 1, there is only a single, point-acting ultrasonic actuator 6 and only a single, point-receiving ultrasonic sensor 7. Due to its design, the ultrasonic actuator 6 can only excite ultrasonic waves in a very unspecific manner, and due to its design, the ultrasonic sensor 7 can only capture ultrasonic waves in a very unspecific manner.

In contrast, the ultrasonic flowmeters 1 shown in the other figures operate with a significant modification. The other ultrasonic flowmeters 1 shown with ultrasonic actuators 6 or ultrasonic sensors 7 are characterized in that at least the ultrasonic transducer 3 designed as an ultrasonic actuator 6 has several excitation structures 10 in the axial direction of the measuring tube 2, wherein the excitation structures 10 are spaced apart from each other in the axial direction of the measuring tube 2. By means of the excitation structures 10, ultrasonic waves 9 are fed into the measuring tube 2 through which the fluid 8 flows, so that a wave pattern of at least one predetermined wave mode of the guided ultrasonic wave 9 is excited in the measuring tube 2 through which the fluid 8 flows, spatially distributed in the axial direction of the measuring tube 2. The excitation structures 10 have contact surfaces 11 to the measuring tube 2 and/or to the fluid 8 guided in the measuring tube 2, wherein acoustic excitation of the measuring tube 2 and/or fluid 8 takes place via the contact surfaces 11.

The multiple excitation structures 10 spaced apart from each other at multiple locations in the direction of extension of the measuring tube 2 allow multiple acoustic excitations to occur simultaneously or with a time delay. These excitations are selected so that they correspond exactly to the characteristic space-time signature, i.e., the wave pattern of the ultrasonic wave 9 propagating through the measuring tube 2 through which the fluid 8 flows, of the predetermined wave mode. The multiple excitation structures 10 spaced apart from one another implement an extensive, structured excitation coating in the direction of the measuring tube 2, enabling more specific excitation of a desired (or several desired) and therefore predetermined wave mode. This is an advantage over the example shown in FIG. 1, which has only a single excitation point. The wave pattern of the desired, predetermined wave mode can thus be imprinted spatially and temporally in the flowed-through measuring tube 2 by means of an excitation coating via the spatially distributed excitation structures 10 along the measuring tube 2.

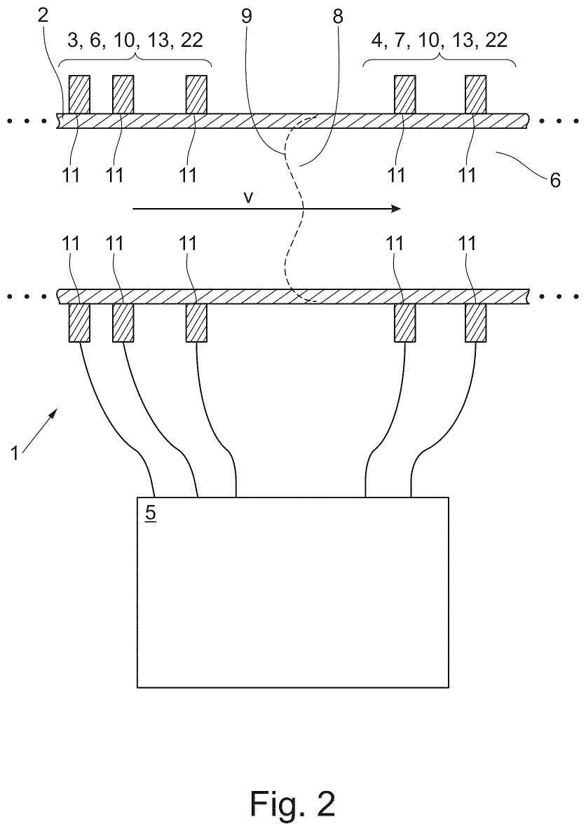

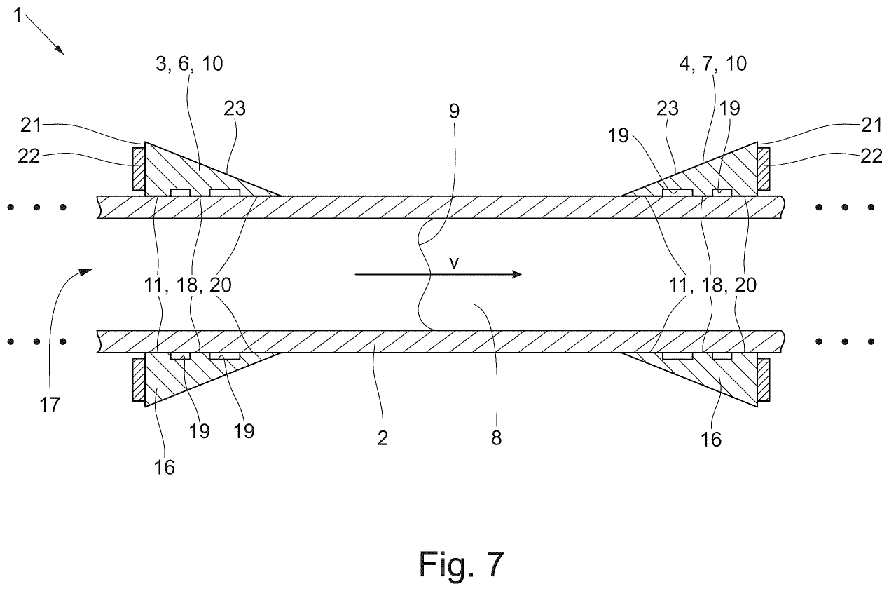

The examples according to FIGS. 2 and 7 have in common that the second ultrasonic transducer 4, which is designed as an ultrasonic sensor 7, is basically designed in the same way as the first ultrasonic transducer 2, which is designed as an ultrasonic actuator 6, meaning that the ultrasonic sensor 7 also has a plurality of excitation structures 10, wherein the excitation structures 10 act as detection structures. In the example shown in FIG. 7, the second ultrasonic transducer 4 is identical in design to the first ultrasonic transducer 3, which is designed as an ultrasonic actuator 6.

In all of the ultrasonic flowmeters 1 shown in the figures, the first ultrasonic transducer 3 is also designed as an ultrasonic sensor 7, and the second ultrasonic transducer 4 is also designed as an ultrasonic actuator 6. This is useful because—as designed above—the control and evaluation unit 5 operates the first ultrasonic transducer 3 and the second ultrasonic transducer 4 in such a way that the flow velocity v of the fluid 8 in the measuring tube 2 is determined by measuring the difference in transit time.

The examples of ultrasonic flowmeters 1 shown in the figures work with measuring tubes 2 with an inner diameter of significantly less than one centimeter. The measuring tubes 2 are designed as flexible hoses, namely made of a perfluoroalkoxy polymer, i.e., an elastic plastic. In other designs not shown here, the measuring tube 2 is mechanically rigid, in particular made of metal, plastic, ceramic, or glass.

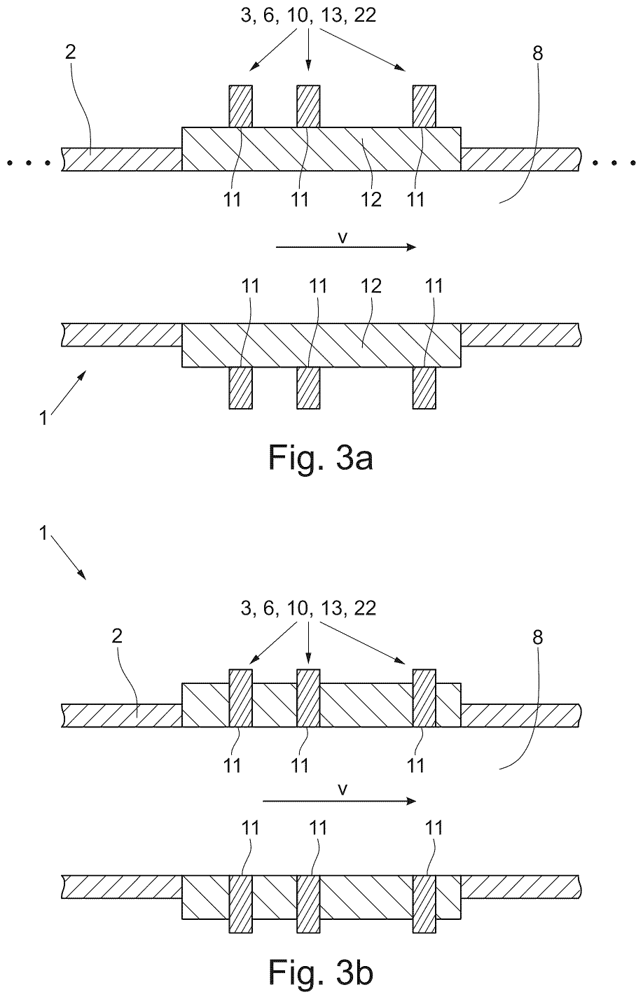

In the ultrasonic flowmeter 1 according to FIG. 3a, the measuring tube 2 is designed as an acoustic coupling piece 12 in the area of the excitation structures 10 to improve the sound transmission from the excitation structure 10 to the fluid 8 in the measuring tube 2.

In the ultrasonic flowmeter 1 according to FIG. 3b, the measuring tube 2 in the area of the excitation structure 10 is formed by the excitation structure 10 itself for direct sound transmission from the excitation structure 10 into the fluid 8 in the measuring tube 2. The contact surfaces 11 thus have direct contact with the fluid 8.

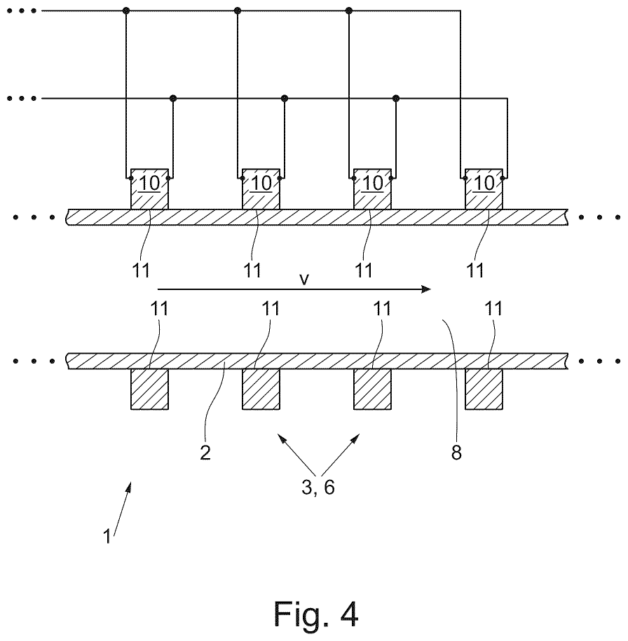

In the ultrasonic flowmeters 1 according to FIGS. 2 to 4, the excitation structures 10 are formed by at least two rings spaced apart from each other in the axial direction of the measuring tube 2 and surrounding the measuring tube 2 in the circumferential direction. In the examples according to FIGS. 2 and 3, the rings of the ultrasonic actuator 6 have different distances from each other and the distances between the rings of the ultrasonic sensor 7 differ from the ring distances of the ultrasonic actuator 6 (FIG. 2). In the examples according to FIG. 4, a different approach is taken: here, the distances between the excitation structures 10 designed as rings are equidistant, which has advantages in terms of manufacturing.

In the ultrasonic flowmeters 1 according to FIGS. 2 and 3, a particularly high degree of flexibility with regard to changing operating and boundary conditions is achieved in that the rings are separate ultrasonic stimulators 22, in particular separate piezo elements 13, wherein the ultrasonic stimulators 22 can be controlled separately by the control and evaluation unit 5. Furthermore, the ultrasonic sensors 7 are also designed with piezo elements 13, and the sensor signals of the individual detection structures 10, which are performed as piezo element rings, can be read out separately.

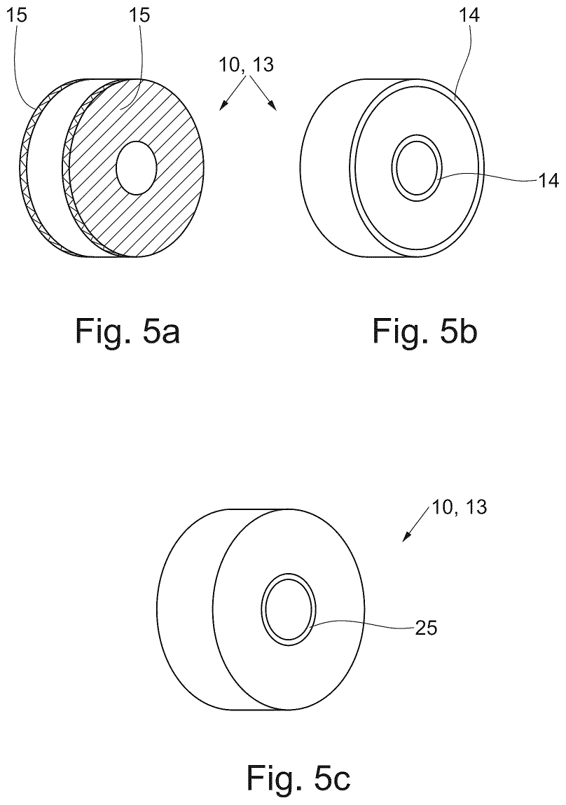

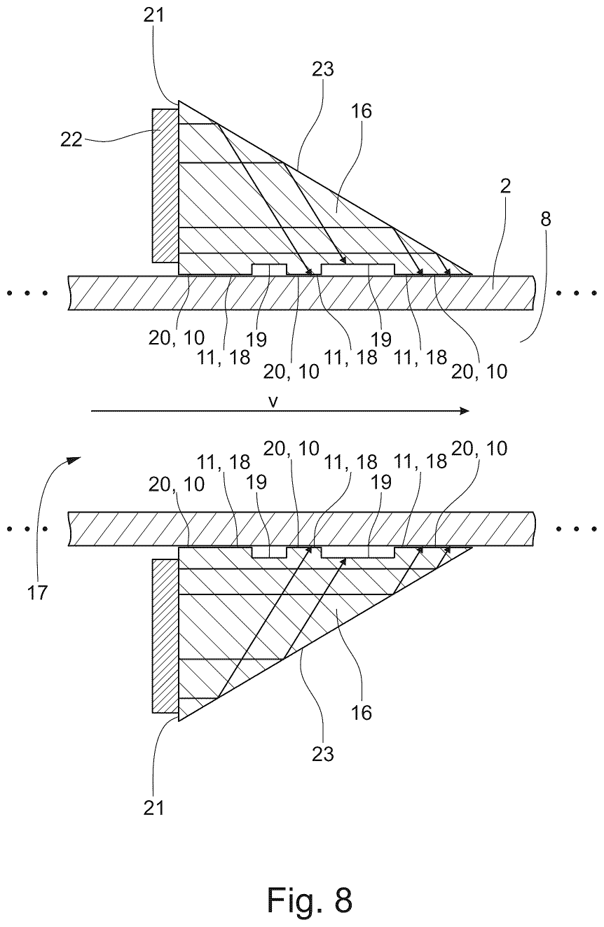

FIGS. 5a, 5b, and 5c show individual excitation or detection structures 10, which are implemented as ring-shaped piezo elements 13. In the piezo element 13 according to FIG. 5a, the ring is contacted by the control and evaluation unit 5 via two opposite base surfaces 15 (axial mode). In the piezo element 13 according to FIG. 5b, the ring is contacted by the control and evaluation unit 5 via an inner and outer lateral surface 14 of the ring (radial mode). FIG. 5c shows a ring-shaped piezo element 13 with a layer 25 that is designed either as an adaptation layer for better transmission of ultrasonic waves (for example, for applications according to FIGS. 2 and 4) or as a damping layer to prevent the transmission of ultrasonic waves (for example, for applications according to FIGS. 7 and 8, if a holder is also to be provided directly on the measuring tube 2, which is not shown).

The separate controllability of the multiple excitation structures 10 spaced apart from one another according to FIG. 2 by the control and evaluation unit 5 makes it possible to excite the multiple excitation structures 10 spaced apart from one another at multiple locations (seen in the direction of the measuring tube 2) in a time-shifted manner. These excitations are performed in such a way that they cause precisely the wave pattern of the ultrasonic wave 9 of the predetermined wave mode propagating through the measuring tube 2 through which the fluid 8 flows. The advantage of time-variable and separate controllability of the rings is their adaptability to changing operating conditions, for example when the fluid 8 changes or even when there is only a change in temperature.

In the ultrasonic flowmeter 1 according to FIG. 4, the multiple excitation structures 10 designed as rings are controlled simultaneously by the control and evaluation unit 5, which simplifies the design of the control and evaluation unit 5. In this case, the distances between the separate rings must be selected so that they cause precisely the wave pattern of the ultrasonic wave 9 of the predetermined wave mode propagating through the measuring tube 2 through which the fluid 8 flows.

In the ultrasonic flowmeter 1 according to FIG. 2, the rings of the ultrasonic actuator 6 are controlled with a time delay in the direction of the ultrasonic sensor 7, so that the ultrasonic wave 9 in the predetermined wave mode is amplified in the direction of the ultrasonic sensor 7. In the direction away from the ultrasonic sensor 7, however, the generated wave amplitudes are lower because they do not overlap in this direction of propagation due to the time-delayed activation. This achieves considerable directional selectivity.

In the ultrasonic transducer 4 designed as ultrasonic sensor 7 according to FIG. 2, selectivity in capturing the wave pattern of the predetermined wave mode is achieved by evaluating the receive signals supplied by the multiple detection structures 10 in a time-gated or time-delayed manner in accordance with the propagation characteristics and the wave pattern of the predetermined wave mode. The signals captured by the two detection structures 10 of the ultrasonic sensor 7 could, for example, be added together, wherein the signal arriving first at the left of the two detection structures 10 is delayed by the absolute value of the time required for an ultrasonic signal 9 of the predetermined wave mode to travel from the left of the two detection structures 10 to the right of the two detection structures 10. Only with a corresponding wave mode could the signals add up due to the phase velocity dependent on the wave mode, whereby a signal input in the expected and predetermined wave mode can be verified due to additive signal strengths.

Similarly, a temporal windowing can be implemented, wherein a signal input at the left of the two detection structures 10 triggers a detection window at the right of the two detection structures 10. If no signal enters this triggered window, it was not an ultrasonic wave 9 in the predetermined wave mode. This requires that the predetermined wave mode and the excitation frequency of the predetermined wave mode be cleverly selected in order to achieve good distinguishability of the predetermined wave mode from other wave modes.

The ultrasonic flowmeter 1 shown in FIGS. 7 and 8 does not work with separate rings, but rather has a conical base body 16 with a central recess 17 for receiving the measuring tube 2, wherein an inner wall 18 of the base body 16 formed by the recess 17 is structured by projections 19 extending in the circumferential direction of the measuring tube 2 in the axial direction of the measuring tube 2. The projections 20 in the inner wall 18 of the base body 16 formed by the recesses 19 form the excitation structures 10. An ultrasonic stimulator 22 is arranged at the base surface 21 of the conical base body 16, which feeds ultrasonic waves (indicated by arrow lines) into the conical base body 16, wherein the ultrasonic waves are at least partially reflected at the lateral surface 23 of the conical base body 16 and excite the guided ultrasonic wave 9 in the measuring tube 2 through which the fluid 8 flows via the projections 20 of the inner wall 18 of the base body 16.

This implementation of the ultrasonic actuator 6 is somewhat more limited than the design with separate rings, since the projections 20 are structurally fixed in the conical base body 16. Furthermore, ultrasonic waves are only generated by one ultrasonic stimulator 22, which feeds the ultrasonic waves into the conical base body 16, wherein the ultrasonic waves are distributed by reflection on the lateral surface 23 in the base body 16 and ultimately fed into the waveguide (measuring tube/fluid).

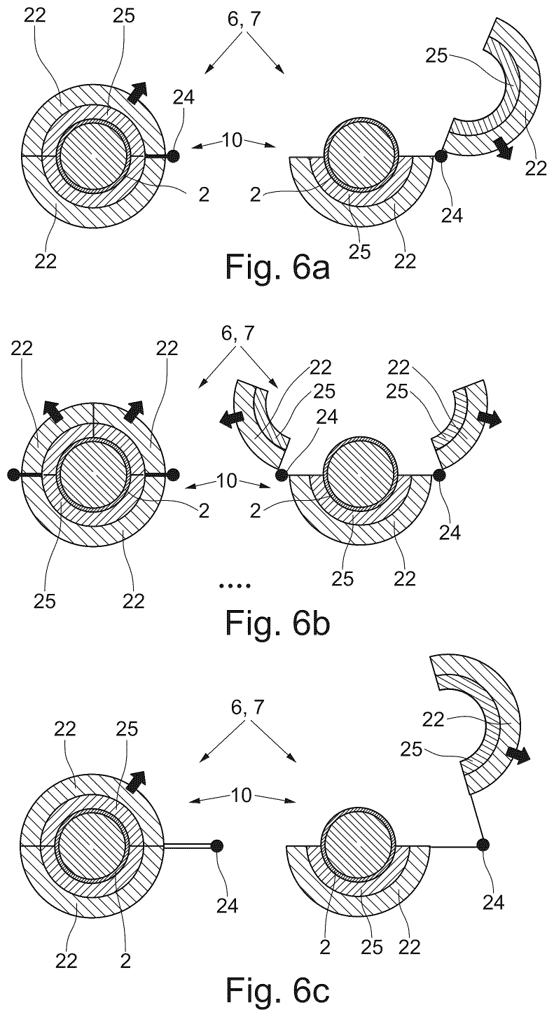

FIGS. 6a to 6c show ultrasonic flowmeters 1 in which the ultrasonic actuator 6 and/or the ultrasonic sensor 7 is designed in multiple parts so that it can be radially attached to the measuring tube 2, in particular wherein the multiple parts are mounted so that they can be pivoted relative to each other via one or more hinges 24. An adaptation layer 25 ensures optimum transmission of the ultrasonic waves from the ultrasonic stimulator 22 to the measuring tube 2 and to the fluid 8 in the measuring tube 2.

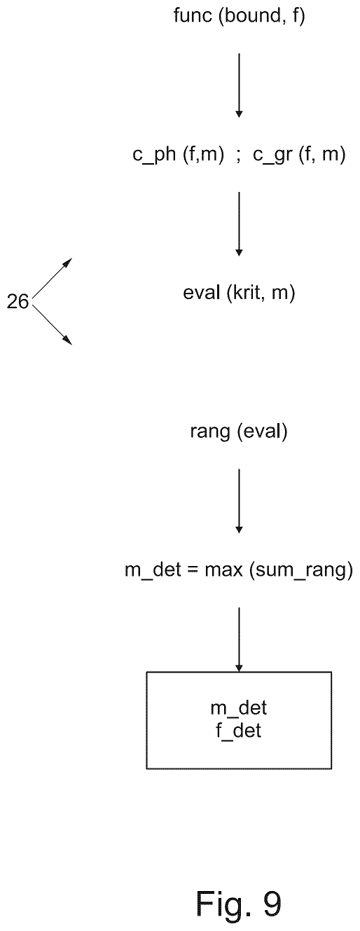

FIGS. 9 to 11 show a method 26 for determining at least one wave mode generated during flow measurement in an ultrasonic flowmeter 1. The ultrasonic flowmeter 1 is of the type described above, i.e., it has a measuring tube 2, a first ultrasonic transducer 3, a second ultrasonic transducer 4, and a control and evaluation unit 5. The first ultrasonic transducer 3 and the second ultrasonic transducer 4 are arranged axially offset on the measuring tube 2, wherein the first ultrasonic transducer 3 is designed at least as an ultrasonic actuator 6, wherein the second ultrasonic transducer 4 is designed at least as an ultrasonic sensor 7, and wherein the control and evaluation unit 5, when the ultrasonic flowmeter 1 is in operation, controls the ultrasonic actuator 6 in such a way that a guided ultrasonic wave 9 is excited in the measuring tube 2 through which a fluid 8 flows.

The ultrasonic sensor 7 receives the guided ultrasonic wave 9 and the control and evaluation unit 5 determines a flow velocity of the fluid 8 by evaluating the received guided ultrasonic wave 9. The ultrasonic transducer 3, designed as an ultrasonic actuator 6, has several excitation structures 10 in the axial direction of the measuring tube 2, wherein the excitation structures 10 are spaced apart from each other in the axial direction of the measuring tube 2. By means of the excitation structures 10, ultrasonic waves are fed into the measuring tube 2 through which the fluid 8 flows, so that the wave pattern of a predetermined wave mode m_det of the guided ultrasonic wave 9 is excited in the measuring tube 2 through which the fluid flows, spatially distributed in the axial direction of extension of the measuring tube 2.

According to FIG. 9, the method 26 provides that, for the geometric and physical boundary conditions bound of the measuring tube 2 through which the fluid 8 flows, the phase velocities c_ph and the group velocities c_gr of sound waves in a frequency range are determined func (bound, f) for a plurality of wave modes m. The wave mode that receives the highest evaluation eval_max when evaluating eval at least one of the following criteria krit at a specific frequency f_det within the frequency range is selected as the predetermined wave mode m_det:
a) the less the phase velocity c_ph and the group velocity c_gr differ from each other, the better,
b) the closer the phase velocity c_ph and/or the group velocity c_gr is to the sound velocity in the fluid, the better,
c) the lower the frequency dependencies of the phase velocity c_ph and the group velocity c_gr are, the better,
d) the greater the smallest difference in phase velocity c_ph between different modes m, the better,
e) the greater the smallest difference in group velocity c_gr between different modes m, the better,
f) the more axisymmetric the mode m is, the better,
g) the more similar the relative change in phase velocity c_ph and/or group velocity c_gr is to a relative change in the sound velocity of the fluid 8, the better,
h) the smaller the attenuation of the amplitude of the mode during propagation in the fluid, the better,
i) the more consistent the amplitude of the mode m is across the inner cross-section of the measuring tube 2, the better.

The result of the method is therefore not only the determination of a desired and thus predetermined wave mode m_det, but also the specific frequency f_det at which the predetermined wave mode m_det is to be excited.

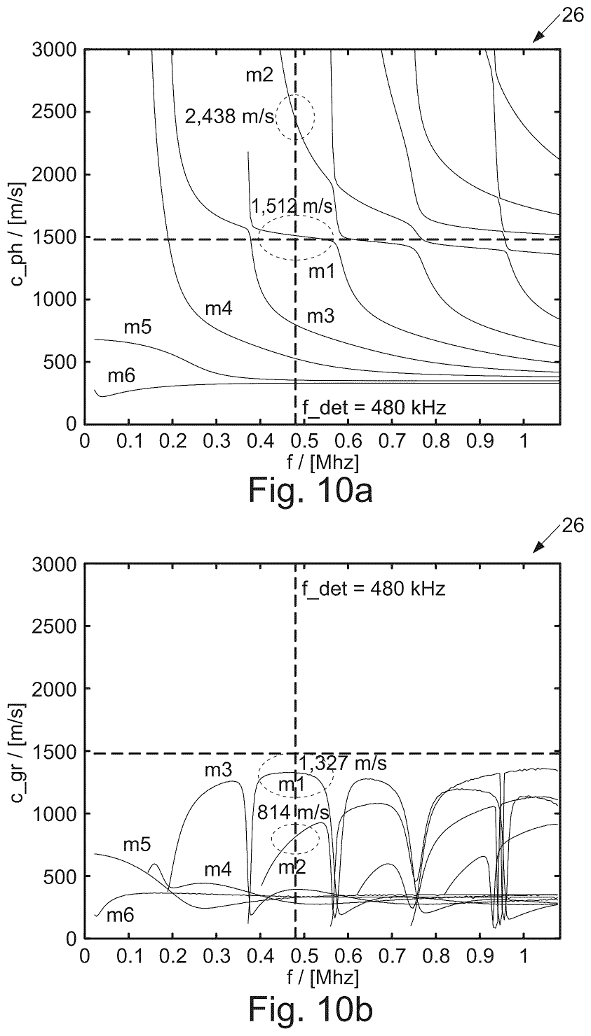

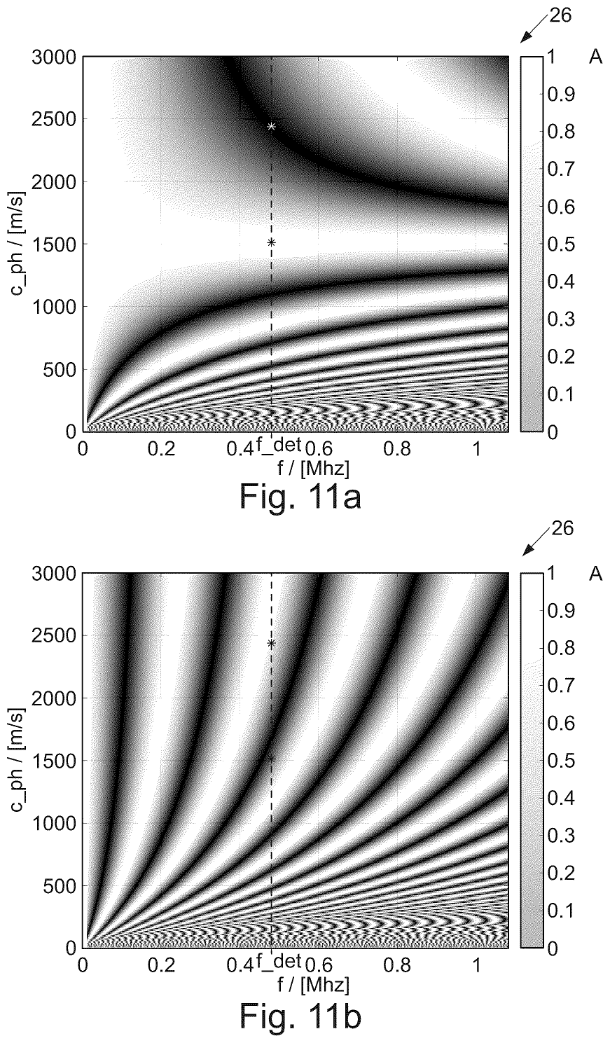

The significance of the criteria has been explained in the general description section. Some of the criteria are illustrated in detail in FIGS. 10 and 11.

FIG. 10a shows the calculated phase velocity c_ph and FIG. 10b shows the calculated group velocity c_gr of ultrasonic waves in a frequency range from 0 to approximately 1 MHz. A straight measuring tube 2 made of an elastic perfluoroalkoxy polymer hose with an outer diameter of 6.35 mm and an inner diameter of 4.35 mm was selected as the boundary conditions. Furthermore, a sound velocity of 1480 m/s and a fluid density of 1000 kg/m\hat{ }3 were assumed for water. Air at normal pressure and normal temperature was assumed for the space outside the measuring tube 2. This calculation does not depend on the specific design of the excitation structures 10, i.e., spatial distances between the excitation structures 10 and any temporal distances with regard to the control of the excitation structures 10. It only concerns the question of propagatable wave modes under the selected geometric and physical boundary conditions of the measuring tube and fluid at frequencies determined as the excited waves.

As can be seen in FIGS. 10a and 10b, both the phase velocity c_ph and the group velocity c_gr of the wave mode m1 are close to the sound velocity of the fluid of 1480 m/s at a frequency of 480 kHz, which leads to a good evaluation for criteria a) and b) (planar wave). Furthermore, at this frequency, mode m1 has low dispersion in phase velocity c_ph and group velocity c_gr, which means that phase velocity c_ph and group velocity c_gr are only slightly dependent on the frequency of the transmitted waves and leads to a good rating for criterion c).

At a frequency of 480 kHz, there is also a large difference between the phase velocity c_ph and the group velocity c_gr between wave mode m1 and the neighboring modes m2 and m3, which leads to a good rating with regard to criteria d) and g).

What is not shown here, but has been calculated, is that the relative change in phase velocity c_ph and/or group velocity c_gr behaves very similarly to a relative change in the sound velocity of the fluid 8 (change in medium), which leads to a good evaluation for criterion g).

Overall, the analysis yields a preferred result for wave mode m1, which is therefore selected as the predetermined wave mode m_det at the determined frequency f_det of 480 kHz, wherein wave mode m2 represents a disturbance factor due to its closest velocity. Knowing that the vibration mode m1 is to be excited at a specific frequency of f_det of 480 kHz, the excitation structures 10 can now be designed in terms of their spatial arrangement along the measuring tube axis and/or their temporal excitation, depending on the existing degrees of freedom. In the present case, two excitation structures 10 with a distance of 4.15 mm and an excitation delay of 2.74 us have been selected.

It is helpful here to answer the question of how the amplitudes of the different modes m1 and m2 behave in relation to each other under the same excitation, which cannot be deduced from FIG. 10. In particular, it is desirable that the amplitude of the predetermined mode is sufficiently high, for example, to achieve a good signal-to-noise ratio. For this purpose, the amplitude A is calculated as the absolute value of the two-dimensional Fourier transform of the wave function, which also includes the properties of the excitation structures, in this case two excitation structures with the specified distance and excitation delay.

The amplitudes A in the form of the absolute value of the two-dimensional Fourier transform of the generated ultrasonic waves, taking into account the design of the excitation structures 10, are coded in gray tones in FIGS. 11a and 11b and normalized to the interval 0 to 1, assuming that the excitation is always the same.

FIG. 11a shows the amplitude A of the resulting ultrasonic wave for the direction of movement of the wave from the ultrasonic actuator 6 to the ultrasonic sensor 7. FIG. 11b, on the other hand, shows the solution of the wave equation for the amplitude A of the resulting ultrasonic wave for the direction of movement of the wave from the ultrasonic actuator 6 away from the ultrasonic sensor 7, i.e., in the opposite direction, away from the actual measuring section.

In both FIG. 11a and FIG. 11b, the wave modes m1 and m2 have been transferred from the corresponding representations in FIG. 10a. FIG. 11a clearly shows that the wave mode m1 in the direction of the ultrasonic sensor 7 has a significantly higher amplitude than the next fastest wave mode m2, which greatly increases the temporal distinguishability of the two wave modes. Furthermore, the amplitude of the wave mode m1 away from the direction of the ultrasonic sensor 7 is significantly suppressed with respect to the wave mode m2 (FIG. 11b), which proves that the wave mode m1 is well suited for the measurement task.

Against this background, the method 26 provides that, for the geometric and physical boundary conditions of the measuring tube 2 through which the fluid 8 flows, taking into account the design of the excitation structures 10, the amplitude A of the sound wave generated at an excitation frequency for at least the predetermined wave mode m_det is determined in a frequency range in dependence on the phase velocity c_ph of the generated sound wave and the design of the excitation structures 10 is rejected and modified if the amplitude A of the determined wave mode m_det does not reach a minimum value. A criterion for such a minimum value here is that the amplitude A of the determined wave mode m_det (wave mode m1) must not be smaller than the amplitude A of the undesirable wave mode m2. This is not the case here, so the design of the excitation structures 10 is retained. If the result were not satisfactory, the test procedure described would be repeated until a design of the excitation structures 10 that could no longer be rejected was found.

A particularly simple method of performing the method 26 is to evaluate the criteria krit by ranking the modes m considered and examined on the basis of the criteria krit in an evaluation order and grading them, and determining the best mode as the specific mode m_det on the basis of the total grade sum_rang achieved.

If different weightings are assigned to criteria krit, these different criteria krit are included in the evaluation with different weightings, which is very easy to do.

After performing the method 26, the associated ultrasonic flowmeter 1 is in any case operated in such a way that the determined frequency f_det within the frequency range is used to excite the predetermined wave mode m_det. To do this, not only the excitation frequency must be taken into account, but also the phase velocity of the predetermined wave mode, in this case the wave mode m1 at the frequency determined f_det of 480 KHz.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An ultrasonic flowmeter comprising:
a measuring tube;
a first ultrasonic transducer;
a second ultrasonic transducer; and
a control and evaluation unit,
wherein the first ultrasonic transducer and the second ultrasonic transducer are arranged axially offset on the measuring tube,
wherein the first ultrasonic transducer is designed at least as an ultrasonic actuator,
wherein the second ultrasonic transducer is designed at least as an ultrasonic sensor,
wherein the control and evaluation unit controls the ultrasonic actuator in an operating state of the ultrasonic flowmeter such that a guided ultrasonic wave is excited in the measuring tube through which a fluid flows, and the guided ultrasonic wave propagates in a combined waveguide comprising the measuring tube and the fluid in the axial direction of the measuring tube,
wherein the ultrasonic sensor receives the guided ultrasonic wave and the control and evaluation unit determines a flow velocity of the fluid by evaluating the received guided ultrasonic wave,
wherein at least the ultrasonic transducer that is designed as an ultrasonic actuator has several excitation structures in the axial direction of extension of the measuring tube,
wherein the excitation structures are spaced apart from each other in the axial direction of the measuring tube, and
wherein ultrasonic waves are fed into the measuring tube through which the fluid flows via the excitation structures flowing through the fluid, so that a wave pattern of at least one predetermined wave mode of the guided ultrasonic wave is excited in the measuring tube flowing through the fluid spatially distributed in the axial direction of the measuring tube.

2. The ultrasonic flowmeter according to claim 1, wherein the second ultrasonic transducer designed as an ultrasonic sensor is designed substantially the same as the first ultrasonic transducer designed as an ultrasonic actuator, so that the excitation structures act as detection structures, or wherein the second ultrasonic transducer is designed identically to the first ultrasonic transducer that is designed as an ultrasonic actuator.

3. The ultrasonic flowmeter according to claim 1, wherein the first ultrasonic transducer is also designed as an ultrasonic sensor and the second ultrasonic transducer is also designed as an ultrasonic actuator, or wherein the control and evaluation unit operates the first ultrasonic transducer and the second ultrasonic transducer such that the flow velocity of the fluid in the measuring tube is determined via a transit time difference measurement.

4. The ultrasonic flowmeter according to claim 1, wherein the measuring tube is mechanically rigid, or made of metal, plastic, ceramic or glass, or wherein the measuring tube is flexible like a hose, or made of an elastic plastic, or a perfluoroalkoxy polymer.

5. The ultrasonic flowmeter according to claim 1, wherein the measuring tube is designed as an acoustic coupling piece in an area of the excitation structures to improve sound transmission from the excitation structure to the fluid in the measuring tube.

6. The ultrasonic flowmeter according to claim 1, wherein the measuring tube in the region of the excitation structure is formed by the excitation structure itself for direct sound transmission from the excitation structure into the fluid in the measuring tube.

7. The ultrasonic flowmeter according to claim 1, wherein the excitation structures are formed by at least two rings spaced apart from each other in the axial direction of the measuring tube and surrounding the measuring tube in the circumferential direction, and wherein with at least three rings, the rings are equidistant from each other.

8. The ultrasonic flowmeter according to claim 7, wherein the rings are separate ultrasonic stimulators or separate piezo elements, or wherein the ultrasonic stimulators are controllable separately by the control and evaluation unit.

9. The ultrasonic flowmeter according to claim 7, wherein the rings are contacted by the control and evaluation unit via an inner and outer lateral surface of the rings, or wherein the rings are controlled by the control and evaluation unit via two opposite base surfaces.

10. The ultrasonic flowmeter according to claim 7, wherein the rings are mounted in a common ring holder, or are connected to the common ring holder via their lateral surfaces, and wherein the common ring holder at least partially comprises material that dampens the crosstalk of ultrasonic waves between the plurality of rings.

11. The ultrasonic flowmeter according to claim 7, wherein the rings of the ultrasonic actuator are driven with a time delay in the direction of the ultrasonic sensor so that the ultrasonic wave is amplified in the predetermined wave mode in the direction of the ultrasonic sensor.

12. The ultrasonic flowmeter according to claim 7, wherein selectivity in the capture of the wave pattern of the predetermined wave mode is achieved by evaluating the receive signals supplied by the plurality of detection structures in a time-gated or time-delayed manner in accordance with propagation characteristics and a wave pattern of the predetermined wave mode.

13. The ultrasonic flowmeter according to claim 1, wherein the ultrasonic actuator comprises a conical base body with a central recess for receiving the measuring tube, wherein an inner wall of the base body formed by the recess is structured by at least one recess extending in a circumferential direction of the measuring tube in the axial direction of extension of the measuring tube, wherein the at least two projections in the inner wall of the base body form the excitation structures, wherein an ultrasonic stimulator is arranged on the base surface of the conical base body, which feeds ultrasonic waves into the conical base body, wherein the ultrasonic waves are at least partially reflected at the lateral surface of the conical base body and excite the guided ultrasonic wave in the measuring tube through which the fluid flows via the projections of the inner wall of the base body.

14. The ultrasonic flowmeter according to claim 13, wherein the ultrasonic stimulator is designed as a ring, or as a ring-shaped piezo element, wherein the ring-shaped piezo element is contacted by the control and evaluation unit via an inner and outer lateral surface of the ring, or wherein the ring-shaped piezo element is controlled by the control and evaluation unit via two opposite base surfaces.

15. The ultrasonic flowmeter according to claim 1, wherein the ultrasonic actuator is designed in multiple parts so that is radially attached to the measuring tube, or wherein the multiple parts are mounted so that they are pivotable relative to each other via one or more hinges.

16. The ultrasonic flowmeter according to claim 1, wherein the predetermined wave mode is determined according to a method comprising:
determining phase velocities and group velocities of sound waves in a frequency range for the geometric and physical boundary conditions of the measuring tube through which the fluid flows; and
performing, for the geometric and physical boundary conditions of the measuring tube through which the fluid flows, a selection of a wave mode that receives the highest rating when evaluating at least one of the following criteria at a specific frequency within the frequency range as the predetermined wave mode:
a) the less the phase velocity and the group velocity differ from each other, the better,
b) the closer the phase velocity and/or the group velocity is to the sound velocity in the fluid, the better,
c) the lower the frequency dependencies of the phase velocity and the group velocity are, the better,
d) the greater the smallest difference in phase velocity between different modes is, the better,
e) the greater the smallest distance in the group velocity between different modes, the better,
f) the more axisymmetric the mode is, the better,
g) the more similar the relative change in phase velocity and/or group velocity is to a relative change in the sound velocity of the fluid, the better,
h) the smaller the attenuation of the amplitude of the mode during propagation in the fluid, the better,
i) the more consistent the amplitude of the mode is across the inner cross-section of the measuring tube, the better.

17. A method to determine at least one wave mode generated during flow measurement in an ultrasonic flowmeter, wherein the ultrasonic flowmeter comprises a measuring tube, a first ultrasonic transducer, a second ultrasonic transducer, and a control and evaluation unit, wherein the first ultrasonic transducer and the second ultrasonic transducer are arranged axially offset on the measuring tube, wherein the first ultrasonic transducer is designed at least as an ultrasonic actuator, wherein the second ultrasonic transducer is designed at least as an ultrasonic sensor, wherein the control and evaluation unit controls the ultrasonic actuator in an operating state of the ultrasonic flowmeter such that a guided ultrasonic wave is excited in the measuring tube through which a fluid flows and the guided ultrasonic wave propagates in a combined waveguide comprising the measuring tube and the fluid in the axial direction of extension of the measuring tube in the measuring tube and in the fluid, wherein the ultrasonic sensor receives the guided ultrasonic wave and the control and evaluation unit determines a flow velocity of the fluid by evaluating the received guided ultrasonic wave, wherein at least the ultrasonic transducer designed as an ultrasonic actuator has several excitation structures in the axial direction of the measuring tube, wherein the excitation structures are spaced apart from each other in the axial direction of the measuring tube, wherein ultrasonic waves are fed into the measuring tube through which the fluid flows, so that the wave pattern of a predetermined wave mode of the guided ultrasonic wave is excited in the measuring tube through which the fluid flows, spaced in the axial direction of the measuring tube, the method comprising:
determining phase velocities and group velocities of sound waves in a frequency range for the geometric and physical boundary conditions of the measuring tube through which the fluid flows; and
performing, for the geometric and physical boundary conditions of the measuring tube through which the fluid flows, a selection of a wave mode that receives the highest rating when evaluating at least one of the following criteria at a specific frequency within the frequency range as the predetermined wave mode:
a) the less the phase velocity and the group velocity differ from each other, the better,
b) the closer the phase velocity and/or the group velocity is to the sound velocity in the fluid, the better,
c) the lower the frequency dependencies of the phase velocity and the group velocity are, the better,
d) the greater the smallest difference in phase velocity between different modes is, the better,
e) the greater the smallest distance in the group velocity between different modes, the better,
f) the more axisymmetric the mode is, the better,
g) the more similar the relative change in phase velocity and/or group velocity is to a relative change in the sound velocity of the fluid, the better,
h) the smaller the attenuation of the amplitude of the mode during propagation in the fluid, the better,
i) the more consistent the amplitude of the mode is across the inner cross-section of the measuring tube, the better.

18. The method according to claim 17, wherein, based on the predetermined wave mode found and the frequency determined, a design of the excitation structures is selected, a spatial distance between excitation structures is selected along the measuring tube axis and/or a temporal distance of the excitation of the excitation structures are selected.

19. The method according to claim 18, wherein, for the geometric and physical boundary conditions of the measuring tube through which the fluid flows, taking into account the design of the excitation structures, an amplitude of the sound wave generated at an excitation frequency is determined for at least the predetermined wave mode in a frequency range, determined depending on the phase velocity of the generated sound wave, and the design of the excitation structures is rejected and modified if the amplitude of the determined wave mode does not reach a minimum value or if the amplitude of the determined wave mode is smaller than the amplitude of an undesirable wave mode, and wherein the process is repeated until a design of the excitation structures that is no longer rejected has been found.

20. The method according to claim 17, wherein the evaluation of the criteria is performed by placing the modes considered and examined on the basis of the criteria in a ranking order and grading them, and by determining the best mode as the specific mode on the basis of the total grade achieved.

21. The method according to claim 20, wherein different criteria with different weightings are included in the evaluation.

22. The method according to claim 17, wherein a specific frequency within the frequency range is the frequency at which the specific mode is excited.
